(19) United States
(12) Patent Application Publication
(10) Pub. No.: US 2008/0319909 A1
(43) Pub. Date: Dec. 25, 2008

(54) System and method for managing the lifecycle of encryption keys

(76) Inventors: George S. Perkins, Columbus, GA (US); Richard E. Sway, Columbus, GA (US)

Correspondence Address: KING & SPALDING LLP, 1180 PEACHTREE STREET, ATLANTA, GA, 30309-3521, US

(21) Appl. No.: 11/821,692

(22) Filed: Jun. 25, 2007

(51) Int. Cl. H04L 9/00; G06Q 40/00

(52) U.S. Cl. 705/50; 380/277

(57) ABSTRACT

Automatically managing the lifecycle of encryption keys. The systems and methods include a workflow engine and workflows that implement actions that generate, maintain, replace, and destroy encryption keys. Workflows may trigger other workflows to automate each step in an encryption key's lifecycle. The systems and methods include reporting on and auditing of the entire hierarchy of keys managed by the system.

### FIELD OF THE INVENTION

This invention relates to systems and methods for managing the lifecycle of encryption keys. More particularly, this invention relates to processes and systems that allow for the automated management of encryption keys used to encrypt protected information through the lifecycle of the keys.

### BACKGROUND OF THE INVENTION

With the explosion of electronic commerce and digital personal information, facilitated by the rapid growth of the Internet, focus has been placed on the protection of financial and personal data. One element in protecting these data is encryption. Encryption is the process of converting information into an unintelligible form except to holders of a specific cryptographic key. By encrypting the information, it is protected against unauthorized disclosure.

Encryption is accomplished through a cryptographic algorithm. The algorithm is used to “lock” the information at one point and “unlock” it at another. Keys are used to lock and unlock the information. In a secret-key or symmetric key encryption, the same key is used to lock and unlock (encrypt and decrypt) the information. In public key or asymmetric key encryption, a public key is used to encrypt the information and a private key is used to decrypt the information. A key is often a numerical value. The length of the key generally determines the relative security of the key.

Many types of information use encryption. One example is the medical industry and patient's medical data. Medical data is encrypted before it is sent over a public network, such as the Internet, to protect this vital information. Another example is the payment card industry, including credit card data and other financial information. Indeed, the credit card industry had taken great steps to ensure that financial data and transaction data is protected. For example, cardholder data must be encrypted when it is stored or transmitted over a public network. This requirement covers everything from producing the credit cards, including information stored on the magnetic strip or embedded chip on the card, to authenticating and authorizing transactions made with the card.

This emphasis on encryption has created a large demand for encryption keys and, more significantly, the robust management of those keys. Organizations must be able to manage the lifecycle of keys, from their creation to their destruction. Indeed, some data protection requirements limit the lifespan of these keys. The key management system must be able to track the status of all of the keys in the system and report on this status. Also, the management system must be flexible to adapt to varying requirements for categories of keys managed by the system.

To date, the current key management structure is incapable of providing a robust level of management. These current system still rely, in part at least, on the manual management of these keys. Often these keys are maintained in paper form. This manual approach makes it nearly impossible to adequately manage and report on the keys.

What is needed is systems and methods that provide for the automated management of encryption keys through the lifecycle of the keys. The systems and methods should be flexible enough to manage a variety of keys.

### SUMMARY OF THE INVENTION

The present invention supports systems and methods that provides for the automated management of encryption keys through the lifecycle of the keys. One aspect of the present invention includes a system for managing a lifecycle of an encryption key. The system includes a workflow engine operable to implement a workflow; and a data store comprising multiple workflows logically connected to the workflow engine, where each workflow includes computer instructions for automatically implementing one or more steps in the lifecycle of the encryption key.

In another aspect of the present invention, a method for managing a lifecycle of an encryption key with a key management system is provided. The method includes the steps of: (a) instantiating a workflow to generate an encryption key in response to a request; (b) automatically generating the encryption key with the workflow; (c) automatically transmitting the encryption key to a target; and (d) continually maintaining the encryption key comprising an automated maintenance function.

In yet another aspect of the present invention, a method for managing a lifecycle of an encryption key is provided. The method includes the steps of: (a) receiving an instruction to remove an existing encryption key from a target; (b) automatically instantiating a workflow to replace the existing encryption key in response to the instruction; (c) automatically generating a replacement encryption key by using the workflow; (d) automatically transmitting the replacement encryption key to the target; (e) automatically removing the existing encryption key from the target; and (f) continually maintaining the encryption key comprising an automated maintenance function.

In still another aspect of the present invention, a system for managing a lifecycle of an encryption key used in the payment card industry is provided. The system includes a workflow engine operable to implement a workflow; a data store comprising a plurality of workflows logically connected to the workflow engine, where each of the plurality of workflows comprise one or more extensible markup language (XML) files for automatically implementing one or more steps in the lifecycle of the encryption key; a secure workstation logically connected to the workflow engine and operable to implement a workflow using the workflow engine; and one or more targets for encryption keys, connected to the workflow engine by a network.

### BRIEF DESCRIPTION OF THE DRAWINGS

FIG. 1 depicts an operating environment in accordance with an exemplary embodiment of the present invention.

FIG. 2 illustrates the lifecycle of encryption keys in accordance with an exemplary embodiment of the present invention.

FIG. 3a depicts a system architecture in accordance with an exemplary embodiment of the present invention.

FIG. 3b depicts a software architecture in accordance with an exemplary embodiment of the present invention.

FIG. 4 depicts a process flow diagram for a managing the lifecycle of encryption keys in accordance with an exemplary embodiment of the present invention.

FIG. 5 depicts a process flow diagram for generating encryption keys in accordance with an exemplary embodiment of the present invention.

FIG. 6 depicts a process flow diagram for maintaining and reporting on encryption keys in accordance with an exemplary embodiment of the present invention.

FIG. 7 depicts a process flow diagram for destroying and replacing encryption keys in accordance with an exemplary embodiment of the present invention.

FIG. 8 depicts a process flow diagram for securely destroying encryption keys in accordance with an exemplary embodiment of the present invention.

### DETAILED DESCRIPTION OF THE EXEMPLARY EMBODIMENTS

Exemplary embodiments of the present invention are provided. These embodiments include systems and methods that manage the lifecycle of encryption keys in an automated fashion. The systems and methods include a workflow engine and workflows that implement actions that generate, maintain, replace, and destroy encryption keys. Workflows may trigger other workflows to automate each step in an encryption key's lifecycle. The systems and methods include reporting on and auditing of the entire hierarchy of keys managed by the system.

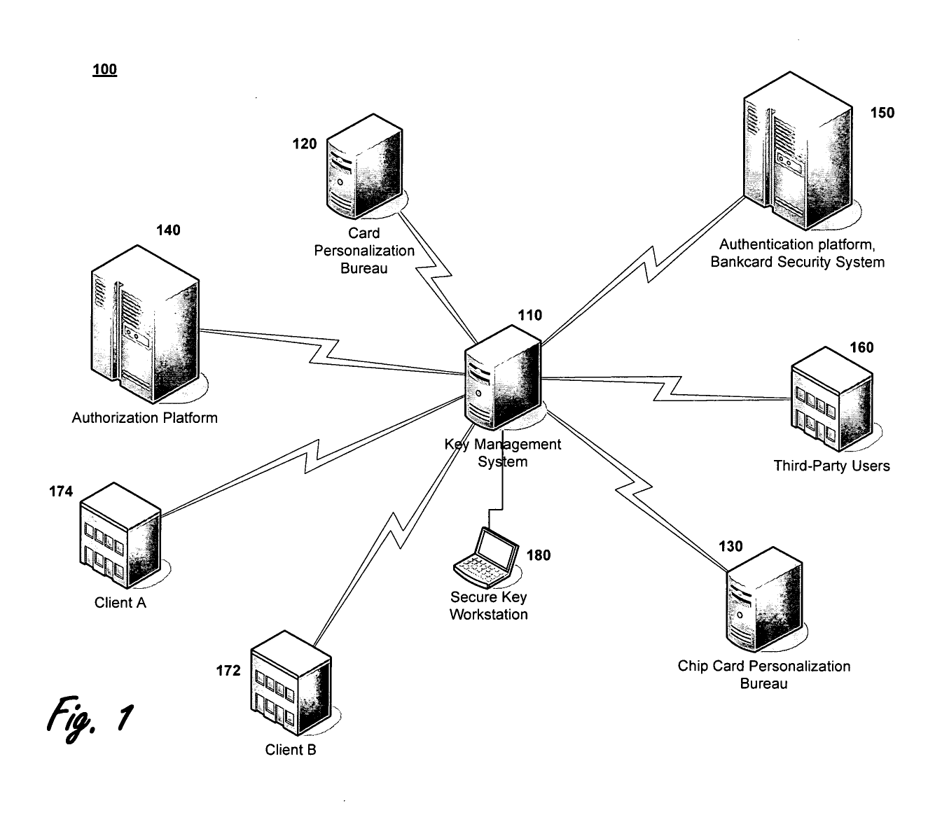

FIG. 1 depicts an operating environment 100 in accordance with an exemplary embodiment of the present invention as it applies to the payment card industry. Referring to FIG. 1, a key management system server 110 is connected to multiple facilities. These facilities represent organizations involved during the lifetime of a payment card. For example, the key management system server 110 is connected to a card personalization bureau 120 and a chip card provider 130. The card personalization bureau 120 produces the traditional credit cards that everyone has in their wallets. These cards typically include embossed information on the front, including a card number, and a magnetic strip on the back. The chip card provider 130 provides a similar card. However, instead of a magnetic stripe, the card, which is sometimes referred to as a “smart card,” includes a computer chip that contains information.

The card personalization bureau 120 and the chip card provider 130 produce the credit cards used by consumers. The key management system server 110 would generate keys in support of this process. Keys would be used to encrypt information concerning a credit card, such as cardholder, account number, and other information, and the information would be sent to the card personalization bureau 120 or the chip card provider 130 to produce the card.

The key management system server 110 also interacts with an authorization platform 140 and a bankcard security system authorization platform 150. These platforms authorize payment card transactions. The key management system server 110 manages keys used in the authentication process. For example, a debit card transaction may require a cardholder to enter a personal identification number (PIN). The PIN is encrypted and sent to an authorization platform, such as authorization platform 140. The authorization platform 140 uses a key to decrypt the PIN as part of the transaction authorization process.

The key management system server 110 also communicates with third-party users, such as a card association. The key management system server 110 also communicates with specific clients 172, 174, such as financial institutions that issue payment cards.

The system 100 may be accessed through a secure key station 180. The secure key station may include hardware and software features that provide security for tasks performed by a user of the secure key station 180. Alternatively, the secure key station 180 may access a secure website or secure server. The secure key station 180 may reside at the key management system 110 or at another facility, such as client 174.

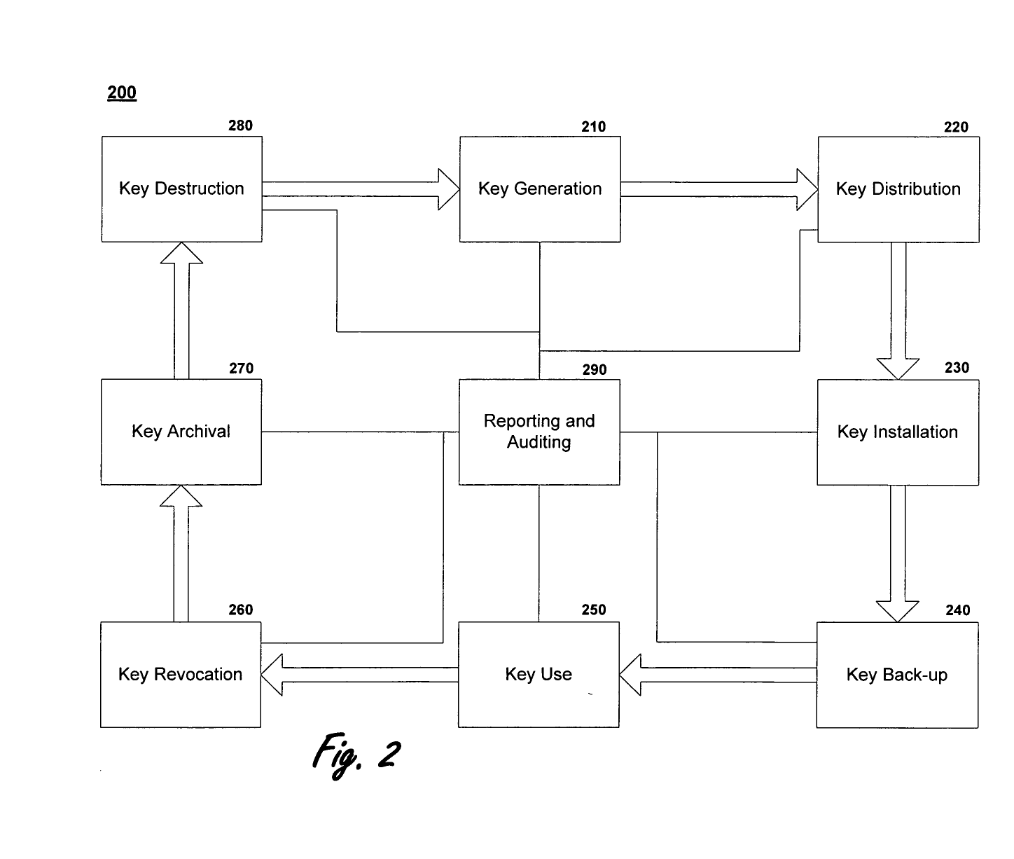

FIG. 2 illustrates the lifecycle 200 of encryption keys in accordance with an exemplary embodiment of the present invention. Referring to FIGS. 1 and 2, the lifecycle 200 begins at a key generation step 210. One or more keys would be generated to support a specific encryption need, such as to encrypt payment card information or the underlying private/public key pair generation and public key certification handling used to facilitate the secure socket layer (SSL) communications protocol. For some applications, such as for a new payment card account, multiple keys may be needed. In this application, keys may be used to secure the account and other information to support making a card while other keys may support authentication and authorization of transactions for the payment card account.

The next step in the lifecycle 200 is a key distribution step 220. In this step, the keys generated at the key generation step 210 are distributed to the platforms that process the information. For example, for a new payment card account, keys may be distributed to card personalization bureau 120 and authorization platform 140.

The next step in the lifecycle 200 is a key installation step 230. The keys are installed on the platforms that receive the keys at step 220. These platforms then use the keys as necessary, such as for encrypting or decrypting account information or approving transactions.

The next step in the lifecycle 200 is key back-up step 240. At this step in the lifecycle 200, the key generated at step 210 is backed-up. This key back-up step 240 includes securely storing a key so that it can be re-provisioned to the key usage end point at any time. For example, if a key is lost from where it was provisioned due a system error, the secure key back-up allows for the lost key to be restored with a minimum of effort.

The next step in the lifecycle 200 is key use step 250. The purpose behind key generation 210 is the ultimate use of the keys. The next step in the lifecycle 200 is a key revocation step 260. The effectiveness of a key to secure data is a function of the length of time the key is used. The longer the key is used, the more likely it may be compromised. Indeed, some encryption requirements limit the time duration that a key may be used. When a key “expires” it is revoked—removed from service and replaced, if necessary. Additionally, a breach in security at a system component may necessitate the system to recall and replace existing keys.

The next step in the lifecycle 200 is a key archival step 270. The key archival step 270 occurs after a key has been withdrawn from active use, i.e. after it has reached its expiry (or obsolescence) date and has been revoked at step 260. Having reached this milestone in its lifecycle a key may still need to be retained just in case there are some legacy data that needs to be decrypted. Also regulatory requirements may necessitate archival of a key.

The next step in the lifecycle 200 is a key destruction step 280. In some cases, keys may be archived indefinitely. In other cases, the key is destroyed. In key destruction step 280, the actual key material is destroyed. However, tracking and auditing data about the key, typically held in a database, will usually be maintained to facilitate reporting on the status of the key.

The key lifecycle 200 can include a reporting and auditing step 290. The reporting and auditing step 290 enables tracking and managing encryption keys regardless of their position in the lifecycle. This reporting and auditing step 290 may be required for specific types of keys. However, for manual management of encryption keys, the reporting and auditing step 290 is extremely difficult. Also, the reporting and auditing step 290 can generate an audit trail that enables the auditing of key management. This auditing capability may be required by a specific encryption key user or by regulatory requirements.

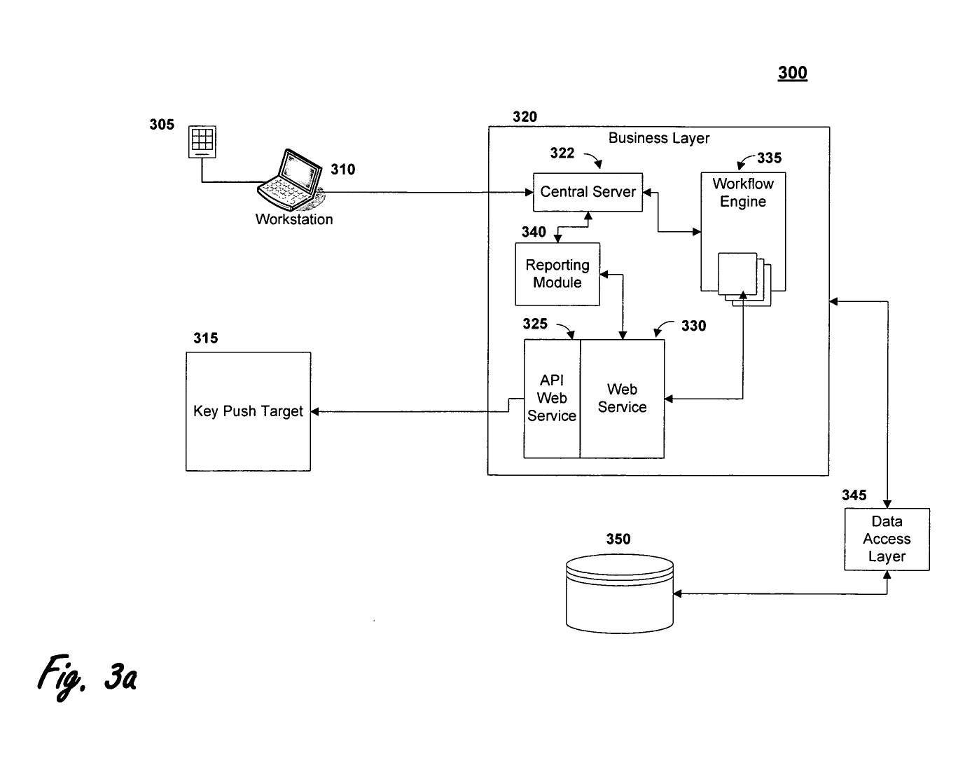

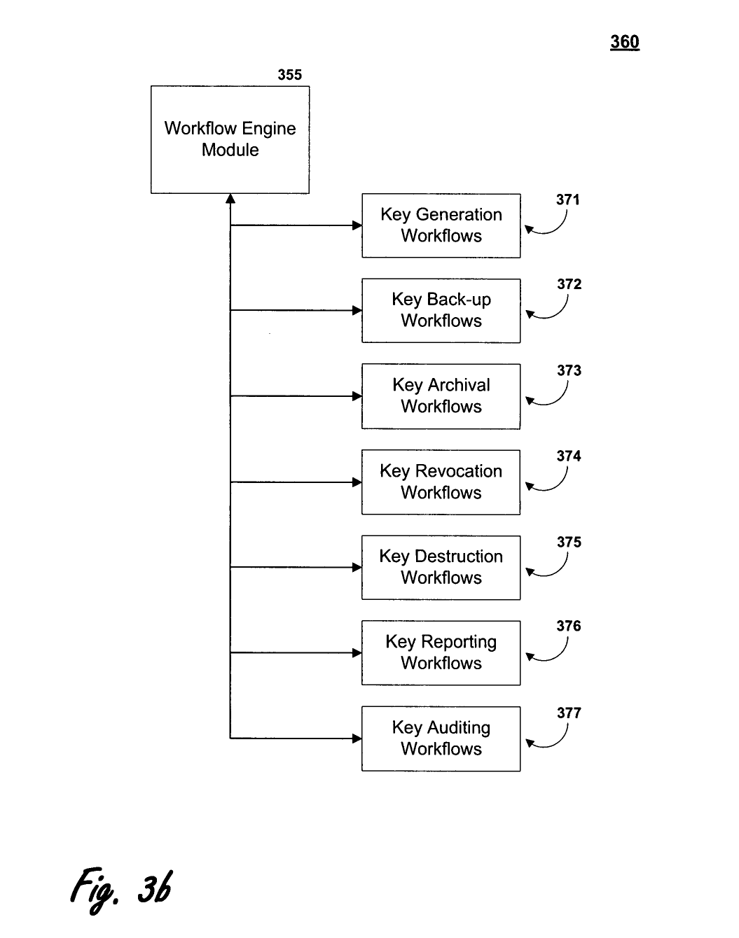

FIG. 3a depicts a system architecture 300 in accordance with an exemplary embodiment of the present invention. Referring to FIGS. 1, 2, and 3a, the architecture 300 includes a secure workstation 310. The secure workstation 310 includes an encrypted card reader 305. The encrypted card reader 305 is operable to read a smartcard. Alternatively, the encrypted card reader 305 may read other card types, including cards with information encoded on a magnetic stripe. The workstation 310 may be used to initiate any of the steps in the encryption key lifecycle 200. The secure workstation 310 may be a desktop computer, a laptop computer, or a device specific for key management tasks. An authorized user would initiate an operation of the secure workstation 310 by using a smart card.

Typically, steps in the encryption key lifecycle may require certain supervisory approval. This layer of oversight helps ensure the security of the keys. In this case, a supervisor would use the workstation 310. One of ordinary skill in the art would appreciate that this type of oversight is not necessary to implement the architecture 300. Of course, the system may include multiple workstations 310 to facilitate key management and specific personnel, such as a supervisor, may control their own workstation 310.

The secure workstation 310 would include software to enable the secure transmission of information to a business layer 320. This software enables an encrypted tunnel to be set up from the encrypted card reader 305 through the secure workstation 310 to the business layer 320. By using the encrypted tunnel, keys or key parts can be entered on the encrypted card reader 305, such as through a keypad, and have the information securely transported to the business layer 320 components for management. The workstation 310 would typically be secure key stations, such as secure key station 180.

The business layer 320 would include a central server 322 for interacting with the secure workstation 310. The central server 322 would launch task-specific workflow engines to implement tasks resulting from the interaction of the workstation 310, using the workflow engine module 335 to perform the task.

The business layer 320 would also include an application programming interface (API) web service module 325, which is logically connected to a web service module 330. The web service module 330 would also launch task-specific workflow engines to implement tasks using the workflow engine module 335. These tasks would result in keys being transmitted to specific push targets, such as key push target 315. This transmission may be accomplished through the use of XML messaging. One of ordinary skill in the art would appreciate that this approach enables the web service module 330 to push keys to disparate targets.

The business layer 320 also includes a reporting module 340. The reporting module 340 may be accessed to generate reports and otherwise audit keys in the key management system 110.

The business layer 320 is also logically connected to a data access layer 345. The data access layer 345 can access database 350. For example, database 350 may store specific workflows that are instantiated by the business layer 320 components. The data access layer 345 would retrieve the specific workflow to be run by the workflow engine module 335. The data access layer 345 may also access data from the database 350 that identifies the access authorizations for users of workstation 310. One of ordinary skill in the art would appreciate that the data access layer 345 may access multiple, distributed databases (not shown) rather that a single database 350. In addition to acting upon specific requests, the central server 322 or web service 330 may automatically initiate tasks. These tasks may include the periodic generation of reports or the revocation, replacement, back-up, archival, and destruction of keys according to a predetermined timetable. Similarly, a detected security breach could automatically trigger one or more tasks.

One of ordinary skill in the art would also appreciate that other architecture structures may be employed. For example, the secure workstation 310 may access the business layer 320 through a web-based system.

FIG. 3b depicts a software architecture 360 in accordance with an exemplary embodiment of the present invention. Referring to FIGS. 1, 2, 3a, and 3b, the workflow engine module 355 can access a variety of workflows. One of ordinary skill in the art would understand that workflows can be written in a variety of computer languages, such as extensible mark-up language (XML), SUN MICROSYSTEM'S JAVA, C, or a proprietary language.

In support of encryption key management tasks, the workflow engine module can run key generation workflows 371, key back-up workflows 372, key archival workflows 373, key revocation workflows 374, key destruction workflows 375, key reporting workflows 376, key auditing workflows 377. Each of these sets of workflows, such as key generation workflows 371, may include a variety of specific workflows, depending on the specific task that is needed. Also, one workflow may initiate one or more other workflows. For example, one of the key revocation workflows 374, may trigger one of the key reporting workflows 376, one of the key destruction workflows 375, one or more of the key auditing workflows 377, and/or one of the key generation workflows 371. That is, the key revocation task may also involve reporting on the revocation, destroying the key, including archival copies, establishing an auditable record, and generating replacement keys.

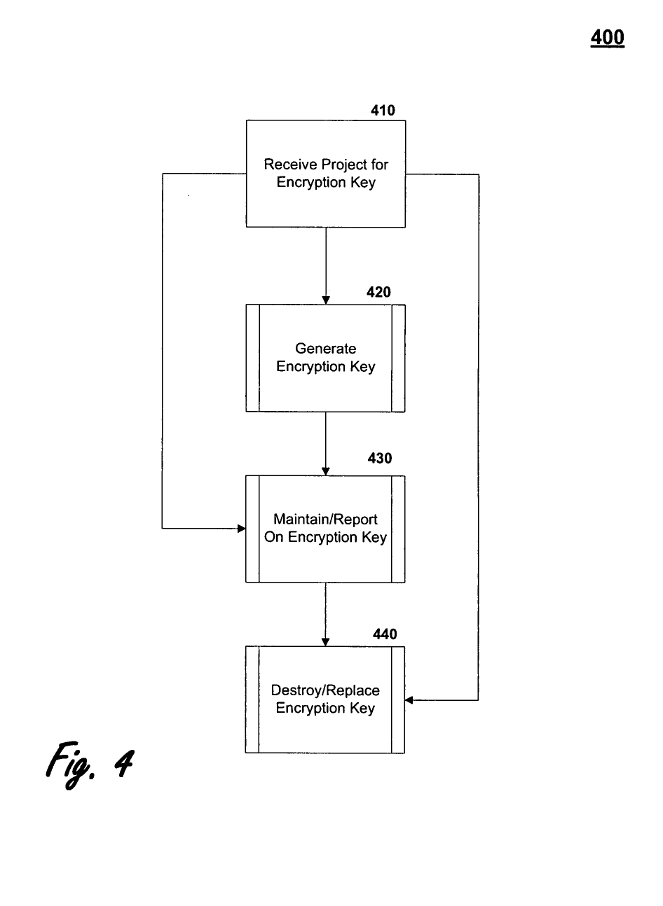

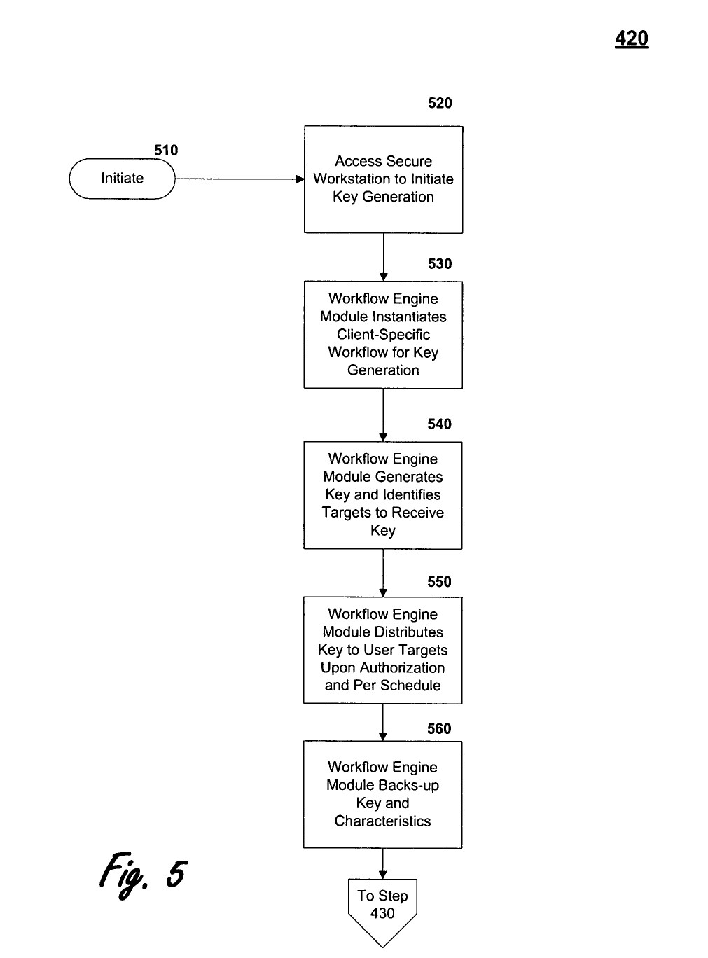

FIG. 4 depicts a process flow diagram 400 for a managing the lifecycle of encryption keys in accordance with an exemplary embodiment of the present invention. Referring to FIGS. 1 and 4, at step 410, the key management system 110 receives a project that requires an encryption key. At step 420, the key management system 110 generates one or more encryption keys for the project. This step is discussed in greater detail below, in connection with FIG. 5.

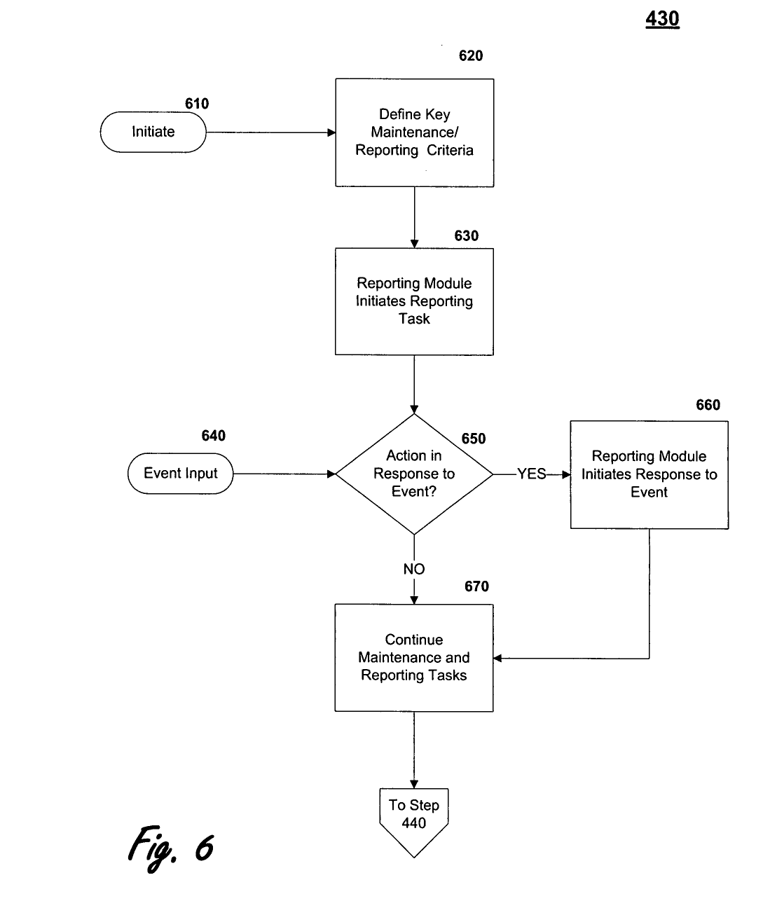

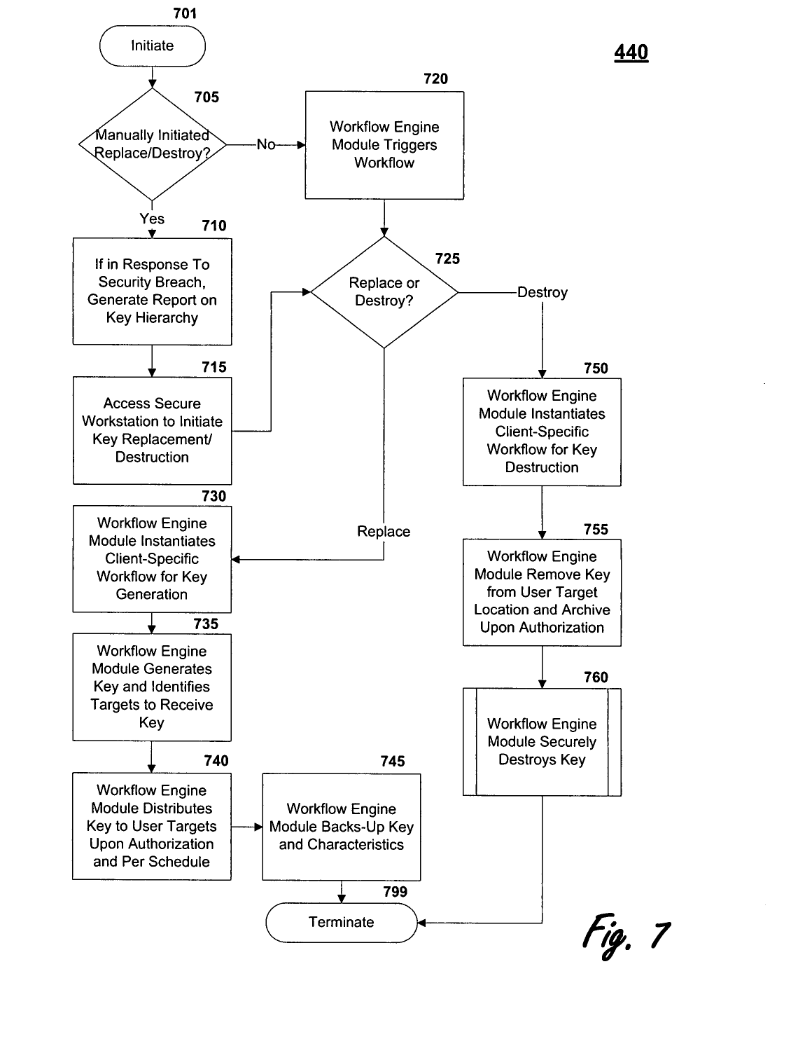

At step 430, the key management system 110 performs maintenance and reporting functions during the period of time the key is in use. This step is described in greater detail below, in connection with FIG. 6. At step 440, the key management system 110 destroys or replaces the encryption key. This step is discussed in greater detail below, in connection with FIG. 7.

FIG. 5 depicts a process flow diagram 420 for generating encryption keys in accordance with an exemplary embodiment of the present invention. Referring to FIGS. 1, 3a, 3b, and 5, at step 510, the process 420 is initiated. At step 520, a user accesses a secure workstation, such as by using a dedicated workstation or by accessing a secure website. At step 530, the workflow engine module 355 instantiates a task-specific and target-specific workflow for key generation, such as one of the key generation workflows 371. Since each application of an encryption key may be different and different target may have unique requirements, each key generation workflow may be unique. One of ordinary skill in the art would understand that the term “target” may represent an outside organization or the “target” may be an internal group within an organization that includes a key management system 110 in support of that organization. In this exemplary embodiment, these targets, also referred to herein as push targets, have the keys pushed to them.

At step 540, the workflow engine module 355 generates the required encryption keys and identifies the targets to receive the keys. In this exemplary embodiment, this key generation is accomplished by running a workflow. At step 550, the workflow engine module 355 distributes the key to the targets. This distribution may be based on a defined schedule and/or may require specific authorizations to complete the distribution. These elements of the process would be defined in the workflow. For example, a key generation workflow that requires an authorization prior to distributing the generated keys would include a workflow element that solicited this authorization. One possible way that this element would be accomplished is by having the workflow present an authorization screen on the authorizer's computer. Alternatively, an electronic mail message may be sent to the authorizer, informing the authorizer to log onto the key management system 110, such as by using workstation 315, and provide the necessary authorization.

This distribution, or pushing, of keys may be accomplished through the use of XML messaging. That is, the web service module 320 and API web service module 325 would employ XML messaging to push keys to the required target or targets. One of ordinary skill in the art would appreciate that this approach enables the web service module 330 to push keys to disparate targets, that is, targets operating a variety of platforms including a variety of hardware security modules (HSMs).

In an exemplary embodiment, the general security strategy of Role-Based Access Control (RBAC) is included. The process 420 may have a variety of predefined privileges, that is, permissions to initiate certain tasks, within the process. A role is a collection of these privileges. Two main roles are Key Custodian A and Key Custodian B. Users are mapped to these roles and granted the privileges by yet another user, the Security Officer, who can administer the users but not generate keys. The workflow restricts which role can perform a given task to ensure that a single person cannot circumvent the system and send keys somewhere without anyone else knowing. These rules may include if a Key Custodian A has generated the key(s) for a project, then the project must be approved by a Key Custodian B. If the Key Custodian B approves the project it may be pushed to the target. If the Key Custodian B does not approve the project and the Key Custodian B edits the project, then a Key Custodian A must examine the changes and approve them before the key(s) can be pushed to the target.

At step 560, the workflow engine module 355 backs-up the key and its characteristics. These characteristics include users, creation date, expiration date, and targets. These characteristics may be used in the ongoing maintenance of the key. This back-up step allows for a easy recovery and replacement of keys. The backed-up key would itself be encrypted. Indeed, a feature of embodiments of the present invention is that keys are never “in the clear,” that is, they are encrypted before they are stored.

FIG. 6 depicts a process flow diagram 330 for maintaining and reporting on encryption keys in accordance with an exemplary embodiment of the present invention. Referring to FIGS. 1, 3a, 3b, and 6, at step 610, the key maintenance phase of the key lifecycle is initiated. This phase occurs after the key has been generated and typically would be initiated manually, perhaps by using the secure workstation 310, following key generation. At step 620, the key maintenance criteria are defined. These parameters may include reporting types and frequencies and event monitoring, such as events that may trigger the need to replace current keys, such as because of a security breach. Some of these criteria may have been defined as part of the key generation process 420. Also, some of these parameters may have been defined during an initial set-up phase for a category of encryption keys. For example, a type of encryption key may have been pre-defined as to the required criteria used to generate and distribute the keys as well as maintaining the keys, such as an expiration date.

At step 630, the reporting module 340 initiates a report. The reporting module 340 can access the entire key management system 110 and other targets to determine the status of keys. At step 640, an event is recorded. This event may be a certain calendar day, such as the first of a month, or may be a specific occurrence, such as a lost key or security breach of a system that stores encryption key information. At step 650, an individual, of the key management system 110, determines if an action in response of the event is needed. If “YES,” the reporting module 340 initiates an action in response to the event at step 660. This action may be a reporting action or may trigger replacing one or more current keys. If “NO,” the process 430 moves to step 670 and continues any ongoing maintenance actions.

FIG. 7 depicts a process flow diagram 440 for destroying and replacing encryption keys in accordance with an exemplary embodiment of the present invention. Referring to FIGS. 1, 3a, 3b, and 7, at step 701, the process 440 to destroy or replace encryption keys is initiated. At step 705, the key management system 110 determines if the process 440 was initiated through a manual process, such as by a user accessing the key management system 110 using a secure workstation, or through an automatic process, such as a scheduled event. An example of such a scheduled event is the expiration of an encryption key currently being used. Of course, even if automatically initiated, human action would likely be involved to approve the replacement action.

If the process 440 was initiated by a manual step, it moves to step 710 and generates a report on key hierarchy. This step is most significant if the process was initiated in response to a security breach in a system that includes keys. The report can be used to quickly assess the possible vulnerabilities from the breach and identify keys to be replaced. Without this understanding of the key hierarchy, all keys may need to be replaced to eliminate any security risk. This extreme measure is costly both in time and effort. As such, one benefit of the exemplary key management system 110 is to reduce the need for such an extreme response by having a complete record of the state of keys in the key management system 110.

At step 715, a user accesses a secure workstation to initiate encryption key replacement or destruction. Alternatively, an encryption key is automatically scheduled to be replaced or destroyed. In that case, process 440 moves from step 705 to step 720, where the workflow engine module 335 triggers the workflow to replace or destroy the encryption key. Of course, this workflow would likely trigger an approval screen as part of the process. The type of approval may differ for manual and automatic processes. The process 440 then moves to step 725, where it determined if the event requires a key to be destroyed or replaced.

If the encryption key is to be replaced, the process 440 moves to step 730 and the workflow engine module 335 instantiates a workflow to generate a key. As discussed previously, in connection with FIG. 5, the workflow may be client-specific and use-specific. At step 735, the workflow engine module 355 generates the required encryption keys and identifies the targets to receive the keys. In this exemplary embodiment, this key generation is accomplished by running a workflow. At step 740, the workflow engine module 355 distributes the key to the targets. This distribution process would be similar to the initial key generation process.

At step 745, the workflow engine module 355 backs-up the key and its characteristics. These characteristics include users, creation date, expiration date, and targets. These characteristics may be used in the ongoing maintenance of the key. This archival step allows for a easy recovery and replacement of keys. Of course, an encryption key may be generated, then backed-up, then sent to a target to put in use, then archived

If the encryption key currently in use needs to be destroyed, the process 440 moves from step 725 to step 750. At this step, the workflow engine module 335 instantiates a workflow for key destruction. At step 755, the workflow causes the key to be removed from the target location and, possibly, from the archive. In some cases, the key may remain in the archive, to decrypt messages that have already been encrypted by have yet to be decrypted or that may be stored while encrypted and may need to be decrypted at a subsequent time. In this exemplary embodiment, this key destruction is accomplished by running a workflow.

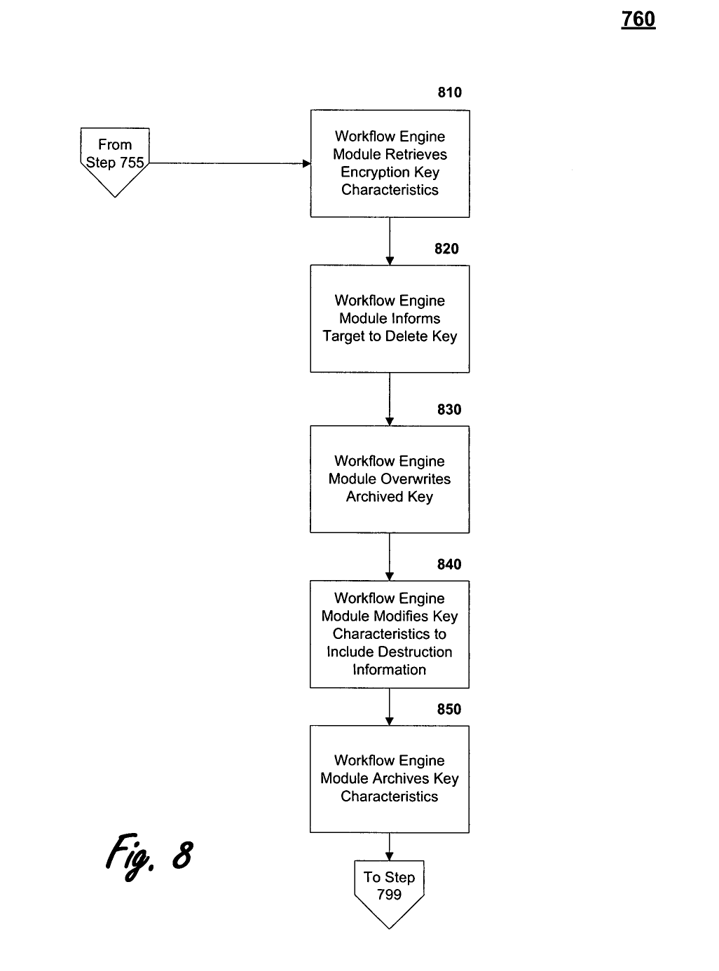

At step 760, the workflow securely destroys the encryption key. This step is described in greater detail below, in connection with FIG. 8. At step 799, the process 440 moves from either step 745 or 760 and terminates.

One of ordinary skill in the art would appreciate that after an encryption key is replaced, the now-obsolete key may be destroyed. Also, one of ordinary skill in the art would appreciate that a workflow that runs to maintain an encryption key may serve to automatically trigger the replacement or destruction of keys.

FIG. 8 depicts a process flow diagram for securely destroying encryption keys in accordance with an exemplary embodiment of the present invention. Referring to FIGS. 3b and 8, at step 810, a workflow instantiated by the workflow engine module 335, such as one of the key destruction workflows 375 retrieves the key characteristics. At step 820, the workflow overwrites the key at the target locations for that key, based on the target information contained in the characteristics.

At step 830, the workflow overwrites the archived key, if necessary. At step 840, the workflow modifies the key characteristics to include destruction information At step 850, the workflow archives the updated characteristics.

One of ordinary skill in the art would appreciate that the present invention supports systems and methods for automatically managing the lifecycle of encryption keys. The systems and methods include a workflow engine and workflows that implement actions that generate, maintain, replace, and destroy encryption keys. Workflows may trigger other workflows to automate each step in an encryption key's lifecycle. The systems and methods include reporting on and auditing of the entire hierarchy of keys managed by the system.

What is claimed:

1. A system for managing a lifecycle of an encryption key comprising:
a workflow engine operable to implement a workflow;
a data store comprising a plurality of workflows logically connected to the workflow engine, wherein each of the plurality of workflows comprise computer instructions for automatically implementing one or more steps in the lifecycle of the encryption key; and
a web service module, logically connected to the workflow engine and operable to distribute the encryption key to a plurality of targets comprising different operating platforms.

2. The system of claim 1 further comprising a reporting module.

3. The system of claim 1 further comprising a secure workstation logically connected to the workflow engine and operable to implement a workflow using the workflow engine.

4. The system of claim 1 wherein the workflow engine is logically connected to a web service.

5. The system of claim 4 further comprising a secure web portal comprising an interface operable to implement a workflow using the workflow engine through a browser.

6. The system of claim 1 further comprising one or more targets for encryption keys, connected to the workflow engine by a network, wherein the targets comprise components of the payment card industry.

7. The system of claim 6 wherein the workflow engine is further operable to determine a hierarchy of each encryption key located at the one or more targets and report the hierarchy.

8. The system of claim 7 wherein the data store comprises workflows for managing each step of the lifecycle of the encryption key.

9. A method for managing a lifecycle of an encryption key with a key management system, comprising the steps of:
instantiating a workflow to generate an encryption key in response to a request;
automatically generating the encryption key with the workflow;
automatically transmitting the encryption key to a target; and
continually maintaining the encryption key comprising an automated maintenance function.

10. The method of claim 9 wherein the step of automatically transmitting the encryption key to a target includes the step of receiving authorization to transmit the key.

11. The method of claim 9 further comprising the step of archiving the encryption key.

12. The method of claim 11 further comprising the step of archiving information comprising characteristics of the encryption key.

13. The method of claim 9 further comprising the steps of:
instantiating a first workflow to maintain the encryption key; and
instantiating a second workflow to destroy the encryption key, wherein instantiating the first workflow and instantiating the second workflow comprise an automatic response to a triggering event.

14. The method of claim 13 wherein the triggering event comprises a pre-scheduled time.

15. A method for managing a lifecycle of an encryption key comprising the steps of:
receiving an instruction to remove an existing encryption key from a target;
automatically instantiating a workflow to replace the existing encryption key in response to the instruction;
automatically generating a replacement encryption key by using the workflow;
automatically transmitting the replacement encryption key to the target;
automatically removing the existing encryption key from the target; and
continually maintaining the encryption key comprising an automated maintenance function.

16. The method of claim 15 wherein the step of automatically removing the existing encryption key from the target comprises overwriting the existing encryption key.

17. The method of claim 15 wherein the instruction to remove the existing encryption key from the target comprises a security breach of the target and the workflow automatically identifies one or more existing keys affected by the security breach.

18. A system for managing a lifecycle of an encryption key used in the payment card industry comprising:
a workflow engine operable to implement a workflow;
a data store comprising a plurality of workflows logically connected to the workflow engine, wherein each of the plurality of workflows comprise one or more program files for automatically implementing one or more steps in the lifecycle of the encryption key;
a secure workstation logically connected to the workflow engine and operable to implement a workflow using the workflow engine and further operable to enable data input during implementation of workflow; and
one or more targets for encryption keys, connected to the workflow engine by a network.

19. The system of claim 18 wherein the secure workstation comprises a computer connected to a secure web portal.

20. The system of claim 18 wherein at least one workflow is operable to transmit an encryption key to one of the targets.
